(19) United States
(12) Patent Application Publication
(10) Pub. No.: US 2003/0175421 A1
(43) Pub. Date: Sep. 18, 2003

(54) PROCESS FOR REDUCING CONTAMINANTS ON SURFACES OF DIE CAST COMPONENTS

(75) Inventors: Kurt F. O'Connor, Carmel, IN (US); Larry William Houk, Kokomo, IN (US); Derek S. Ferraro, Kokomo, IN (US); Mary A. Beam, Kokomo, IN (US); Larry G. Hyman, Russiaville, IN (US); Henry M. Sanftleben, Carmel, IN (US); B. Samuel Platt, Kokomo, IN (US)

Correspondence Address: Jim L. Funke, Delphi Technologies, One Corporate Center, P.O. Box 9005, Kokomo, IN, 46904-9005, US

(73) Assignee: DELPHI TECHNOLOGIES, INC., Troy, MI (US)

(21) Appl. No.: 10/248,061

(22) Filed: Dec. 13, 2002

Related U.S. Application Data
(60) Provisional application No. 60/364,162, filed on Mar. 13, 2002.

(51) Int. Cl. B05D 3/08

(52) U.S. Cl. 427/224

(57) ABSTRACT

A process of cleaning a component following a forming operation that has left a residue on the component surface. The process comprises a thermal treatment during which the surface of the component is subjected to a controlled open flame, preferably in the presence of a limited amount of excess oxygen. Residues can be removed by the open flame to the extent that adhesion of a coating to the component surface can be greatly enhanced. Surface residue levels prior to the thermal treatment can be reduced by the use of lubricants prepared by diluting with de-ionized water or reverse osmosis water, thereby further increasing the likelihood of a residue-free surface having optimal adhesion properties. Under some circumstances, residue levels can be sufficiently reduced with the use of lubricants diluted with de-ionized or reverse osmosis water such that the thermal treatment can be omitted.

### CROSS REFERENCE TO RELATED APPLICATIONS

This application claims the benefit of U.S. Provisional Application No. 60/364,162, filed Mar. 13, 2002.

### BACKGROUND OF INVENTION

1. Field of the Invention

The present invention generally relates to processing of die cast components. More particularly, this invention relates to processes for improving the adhesion of coatings on die cast components.

2. Description of the Related Art

Aluminum, magnesium and zinc alloy components produced by die casting, such as steering wheels, instrument panel frames and electronic housings used in the automotive industry, typically have a film of oils, waxes, resins, etc., that are residues of release agents used in the die casting process. If a die cast component requires a coating, such as a paint or an adhesive coating, the presence of such residues on the component surface can greatly reduce the ability of the coating to bond to the surface. For some components that require the coating to form an environmentally protective seal, poor adhesion can create a leak path for water and other possible contaminants that can shorten the life of the component. As a result, die cast components typically undergo steam cleaning, hot water and soap washes, vibration cleaning and/or shot blasting following die casting and prior to coating deposition. While such cleaning treatments have met with success, lubricant residue levels following these conventional treatments can exceed stricter cleanliness specifications imposed on certain die cast components to ensure adequate coating adhesion, necessitating additional cleaning treatments that increase product cost.

### SUMMARY OF INVENTION

The present invention provides a process of cleaning a die cast component following a die casting operation that has left a die casting residue on a surface of the component. The process comprises subjecting the surface of the component to a controlled flame that burns off the die casting residue. The residue can be removed by the flame to the extent that adhesion of a coating to the component surface can be greatly enhanced. While not wishing to be held to any particular theory, it is believed that direct contact with an open flame is necessary, and that the presence of a limited amount of excess oxygen during the thermal treatment promotes the removal of those residues most detrimental to the adhesion of a coating to the surface of a die cast component. Thermal treatments of die cast components without an open flame has not been found to be effective in removing these residues.

According to another aspect of the invention, surface residue levels prior to the thermal treatment can be reduced by the use of lubricants prepared by diluting with de-ionized (DI) water or reverse osmosis (RO) water, thereby further increasing the likelihood of a residue-free surface having optimal adhesion properties. Under some circumstances, residue levels can be sufficiently reduced with the use of lubricants diluted with DI or RO water such that the thermal treatment can be omitted.

Other objects and advantages of this invention will be better appreciated from the following detailed description.

### DETAILED DESCRIPTION

The invention will be discussed in reference to tests performed on aluminum alloy components produced by die casting operations. However, those skilled in the art will appreciate that the teachings and benefits of this invention are applicable to components formed of various materials and by various processes, in which a surface residue must be reduced or eliminated in order to promote adhesion of a coating to the component surface. Notable examples of other die cast materials include magnesium and zinc alloys commonly used to produce components for the automotive industry.

In an investigation leading up to the present invention, certain die cast aluminum alloy components were selected on the basis of being susceptible to poor adhesion by protective adhesive coatings as a result of residues from die lubricants. The components were formed of various die casting alloys, including an aluminum alloy disclosed in co-pending and commonly-assigned U.S. patent application Ser. No. 09/777,769 (U.S. patent application Publication No. 2002/0106301 A1) to O'Connor, the disclosure of which is incorporated herein by reference. The O'Connor alloy used in this investigation had a nominal composition of, by weight, about 9.04 percent silicon, about 0.97 percent iron, about 0.07 percent copper, about 0.30 percent manganese, about 0.44 percent magnesium, about 0.12 percent zinc, about 0.001 percent nickel, about 0.007 percent tin, about 0.03 percent titanium, about 0.012 percent chromium, the balance essentially aluminum. Other aluminum alloys used in this investigation included Aluminum Association (AA) 413 and 360.

The die lubricant used in the investigation was prepared by diluting a lubricating agent with water from a municipal source, as is conventionally done. The lubricating agent used is commercially-available under the name 3188 from Chemtrend. The composition of 3188 is believed to contain animal and/or vegetable fat(s), silicone oil(s) and polymer wax(es), in addition to other possible additives. Following application of the diluted lubricating agent to the surfaces of the forming dies, the components were die cast at die temperatures of about 150° C. to about 250° C., which is at the low end of a 200° C. to 350° C. range typical for aluminum die casting operations, but identified as being particularly appropriate for the 3188 lubricant to promote the removal of the lubricant during the die casting operation. Following the die casting operations, some of the components were cleaned by such conventional treatments as steam cleaning, hot water and soap washes, vibration cleaning or shot blasting. Other components were thermally treated by transferring the components on a conveyor through open flames produced by two natural gas-fired burners, each rated at 180,000 Btu. Each of these components was passed through the upper end of the flames, and contacted the flames for a duration of about fifteen seconds. Examination of the flame-treated components evidenced that essentially all hydrocarbon-based residues of the die lubricant had been effectively burned off. In addition, the surfaces of these components were found to be substantially free of minerals present in the water used to dilute the lubricant.

Following their respective flame treatments, and without any additional surface treatments performed to remove any combustion residues that might have been present as a result of the flame treatments, adhesive coatings of Dow Chemical 6265 Dispersed Adhesive were applied to the surfaces of the components. The components were then evaluated using a peel-type test to determine the strength of coating adhesion. The results of this test showed that the coatings deposited on those components processed by steam cleaning, hot water and soap washes, vibration cleaning or shot blasting readily failed at the coating-to-surface interface. In contrast, those components subjected to the flame treatment of this invention exhibited far superior adhesion, with coating failures occurring within the coatings themselves and not at the coating-to-surface interface.

The thermal treatment performed in the above investigation appeared to be particularly effect on those components formed of the aluminum alloy disclosed in O'Connor. The O'Connor alloy is disclosed as comprising, by weight, at least 87 percent aluminum, about 4.5 to about 12 percent silicon, not more than 0.08 percent copper, and about 0.8 to about 2.0 percent iron. While not wishing to be held to any particular theory, it is believed that this enhanced effect is the result of the growth of a thicker aluminum oxide scale on the component surface during the thermal treatment.

Further evaluations were conducted with aluminum alloy components using the thermal treatment described above, in which the components were transported on a conveyor through an open flame produced by a Flynn 3 Slotted Burner Ribbon Burner, commercially available from the Flynn Burner Corporation. The evaluations evidenced that the parameters identified in Table I below affected the thermal cleaning process, and established the approximate preferred ranges and suitable ranges for these parameters as set forth in Table 1.

TABLE I

| Parameter | Preferred | Range |
|---|---|---|
| Plasma Value | 48 | 42 to 50 |
| Conveyor Speed (ft./min.) | 10 | 2 to 15 |
| Conveyor Speed (in/mm.) | 3 | 0.6 to 5 |
| Combustion Control (airflow) value (oz./in²) | 28 | 12 to 28 |
| Combustion Control (airflow) value (g/mm²) | 1.2 | 0.5 to 1.2 |
| Distance between burner and component | 0.75 | 0.250 to 5 |
| (inch) | | |
| Distance between burner and component | 20 | 6 to 130 |
| (mm) | | |

Plasma Value is a term used by a Plasma Value (PV) scale developed by the Flynn Burner Corporation, New Rochelle N.Y. 10902 USA, to provide a numerical indication of the amount of excess oxygen or excess fuel gas in the flame plasma or products of combustion (POC's) produced when a mixture of air and fuel gas is burned. The scale is based on a range of 0 to 100 centered around the stoichiometric combustion point of a selected air/gas mixture, where a value of 50 corresponds to a flame plasma containing no excess oxygen or excess fuel gas, i.e., stoichiometric combustion in which all combustible gasses and oxygen in the air/fuel mixture were reacted. Each unit of the PV scale represents 0.1 molar percent, with values below 50 indicating the presence of excess oxygen in the flame plasma (corresponding to a lean air/fuel mixture), and values above 50 indicating the presence of excess fuel gas in the flame plasma (corresponding to a rich air/fuel mixture). As such, the range of 42 to 50 in Table I indicates that the flame plasma contains no excess oxygen or fuel gas (PV=50) up to about 0.8 molar % excess oxygen (PV=42), and the preferred PV of 48 indicates that the flame plasma contains about 0.2 molar % excess oxygen.

In a second investigation, the effect that the water used to form the die lubricant used in the die casting operation was evaluated. In the investigation, die lubricants were prepared by diluting the Chemtrend 3188 lubricant with either de-ionized (DI) water or water from the same municipal source used in the first investigation. Aluminum alloys used in the previous investigation were again die cast using dies coated with the diluted die lubricant and heated to temperatures of about 150° C. to about 250° C. Following the die casting operation and without undergoing a cleaning operation, ionics testing was performed on the surfaces of the die castings. Results were that the surfaces of those die castings processed with the lubricant diluted with municipal water had inorganic levels of about 4.6 mg/cm² on average (attributed to hard water minerals present in the municipal water), while the surfaces of the die castings processed with the lubricant diluted with

DI water had much lower inorganic levels, averaging about 1.04 mg/cm² of casting surface. In view of these results, the use of DI water (or, it was further concluded, RO water) may be sufficient in some applications to achieve adequate adhesion following conventional cleaning treatments (steam cleaning, hot water and soap washes, vibration cleaning or shot blasting). Alternatively, the die cast components may be further subjected to a thermal treatment in accordance with the first investigation to remove hydrocarbon-based residues of the die lubricant.

An important benefit of reducing the level of inorganics on the surface of a die cast housing containing electronic circuitry is related to water ingress. Particularly, electrical shorting caused by dendritic growth of aluminum traces on circuit boards housed within die cast housings has been observed after water has entered the housing. It is believed that dendritic growth is promoted by contact with droplets of water containing relatively high levels of inorganics. From the above investigation, it was concluded that by diluting the die lubricant with water that is substantially free of inorganics, such as DI or RO water, surfaces of the die cast component will have reduced levels of inorganics. Consequently, lower levels of inorganics are available for dissolving with water that might enter the housing, thereby reducing the risk of shorting by dendritic growth.

While the invention has been described in terms of specific embodiments, it is apparent that other forms could be adopted by one skilled in the art. Accordingly, the scope of the invention is to be limited only by the following claims.

1] a process of cleaning a component produced by a forming operation that has left a residue of a lubricant on a surface of the component, the process comprising the step of subjecting the surface to a flame that burns off the residue:

2] A process according to claim 1, wherein the forming operation is a die casting operation, the component is a die cast component, and the lubricant is a die casting lubricant.

3] A process according to claim 1, further comprising the step of depositing a coating on the surface following the subjecting step.

4] A process according to claim 3, wherein the coating forms a watertight seal on the surface.

5] A process according to claim 1, wherein the flame is an open flame produced by a natural gas-fired burner.

6] A process according to claim 5, wherein the flame is fueled by a natural gas-oxygen mixture containing excess oxygen.

7] A process according to claim 5, wherein the flame contains no excess oxygen or natural gas up to an excess of about 0.8 molar percent oxygen above the stoichiometric combustion point of oxygen and natural gas.

8] A process according to claim 5, wherein the flame contains an excess of about 0.2 molar percent oxygen above the stoichiometric combustion point of oxygen and natural gas.

9] A process according to claim 5, wherein the subjecting step comprises passing the component through the flame for a duration of about fifteen seconds or more.

10] A process according to claim 1, wherein the residue left on the surface of the component following the forming operation is a remnant of a die lubricant diluted with de-ionized water or reverse osmosis water.

11] A process according to claim 1, wherein the component is formed of an aluminum, magnesium or zinc alloy.

12] A process according to claim 1, wherein the component is formed of an aluminum alloy comprising, by weight, at least 87 percent aluminum, about 4.5 to about 12 percent silicon, not more than 0.08 percent copper, and about 0.8 to about 2.0 percent iron.

13] A process of producing a die cast component, the process comprising the steps of:
performing a die casting operation to produce the component, the die casting operation using a die lubricant comprising a lubricating agent, the die casting operation resulting in a residue of the die lubricant on a surface of the component;
passing the surface of the component through an open flame that burns off the residue; and then
depositing a coating on the surface that adheres to the surface, the adhesion of the coating to the surface being enhanced by the absence of the residue.

14] A process according to claim 13, wherein the coating forms a watertight seal on the surface.

15] A process according to claim 13, wherein the flame is fueled by a natural gas-oxygen mixture containing excess oxygen.

16] A process according to claim 13, wherein the flame contains no excess oxygen or natural gas up to an excess of about 0.8 molar percent oxygen above the stoichiometric combustion point of oxygen and natural gas.

17] A process according to claim 13, wherein the flame contains an excess of about 0.2 molar percent oxygen above the stoichiometric combustion point of oxygen and natural gas.

18] A process according to claim 13, wherein the die lubricant further comprises de-ionized or reverse osmosis water.

19] A process according to claim 13, wherein the component is formed of an aluminum, magnesium or zinc alloy.

20] A process according to claim 13, wherein the component is formed of an aluminum alloy comprising, by weight, at least 87 percent aluminum, about 4.5 to about 12 percent silicon, not more than 0.08 percent copper, and about 0.8 to about 2.0 percent iron.

21] A process for reducing residue levels of a lubricant on a surface of a component produced by a forming operation, the process comprising the steps of:
preparing the lubricant by diluting a lubricating agent with de-ionized or reverse osmosis water;
applying the lubricant to a forming tool; and then
forming the component with the forming tool, the surface of the component having a residue of the lubricant.

22] A process according to claim 21, wherein the forming operation is a die casting operation, the component is a die cast component, and the lubricant is a die casting lubricant.

23] A process according to claim 21, further comprising the step of depositing a coating on the surface following the forming operation.

24] A process according to claim 23, wherein the coating forms a watertight seal on the surface.

25] A process according to claim 21, further comprising the step of subjecting the surface of the component to a flame that substantially burns off the residue.

26] A process according to claim 25, wherein the flame is an open flame produced by a natural gas-fired burner.

27] A process according to claim 26, wherein the flame is fueled by a natural gas-oxygen mixture containing excess oxygen.

28] A process according to claim 26, wherein the flame contains no excess oxygen or natural gas up to an excess of about 0.8 molar percent oxygen above the stoichiometric combustion point of oxygen and natural gas.

29] A process according to claim 26, wherein the flame contains an excess of about 0.2 molar percent oxygen above the stoichiometric combustion point of oxygen and natural gas.

30] A process according to claim 21, wherein the component is formed as a housing, the process further comprising the step of enclosing an electronic circuitry in the housing.

31] A process according to claim 21, wherein the component is formed of an aluminum, magnesium or zinc alloy.

32] A process according to claim 21, wherein the component is formed of an aluminum alloy comprising, by weight, at least 87 percent aluminum, about 4.5 to about 12 percent silicon, not more than 0.08 percent copper, and about 0.8 to about 2.0 percent iron.
